(19) United States
(12) Patent Application Publication
(10) Pub. No.: US 2008/0136770 A1
(43) Pub. Date: Jun. 12, 2008

(54) Thermal Control for LED Backlight

(75) Inventors: Arkadiy PEKER, New Hyde Park, NY (US); Dror KORCHARZ, Bat Yam (IL); Alon FERENTZ, Bat Yam (IL)

Correspondence Address: MICROSEMI CORP - AMSG LTD., C/O LANDONIP, INC, 1700 DIAGONAL ROAD, SUITE 450, ALEXANDRIA, VA, 22202-3709, US

(73) Assignee: MICROSEMI CORP. - ANALOG MIXED SIGNAL GROUP LTD., Hod Hasharon (IL)

(21) Appl. No.: 11/949,085

(22) Filed: Dec. 3, 2007

Related U.S. Application Data
(60) Provisional application No. 60/868,943, filed on Dec. 7, 2006.

(51) Int. Cl. G09G 3/36

(52) U.S. Cl. 345/102

(57) ABSTRACT

A backlighting system comprising: a controller; at least one luminaire comprising a plurality of LEDs; and at least one thermal sensor in communication with the controller, the controller being operative to control the luminance of the at least one luminaire responsive to the at least one thermal sensor. Preferably, the control of the luminance comprises: in the event that a temperature indication responsive to an output of the at least one thermal sensor is greater than a first pre-determined maximum, reducing the luminance of at least one of the at least one luminaire.

### CROSS-REFERENCE TO RELATED APPLICATIONS

This application claims priority from U.S. Provisional Patent Application Ser. No. 60/868,943 filed Dec. 7, 2006, entitled “Thermal Control for LED Backlight”, the entire contents of which is incorporated herein by reference.

### BACKGROUND OF THE INVENTION

The present invention relates to the field of light emitting diode based lighting and more particularly to a means of preventing thermal runaway in an LED based back light system.

Light emitting diodes (LEDs) and in particular high intensity and medium intensity LED strings are rapidly coming into wide use for lighting applications. LEDs with an overall high luminance are useful in a number of applications including backlighting for liquid crystal display (LCD) based monitors and televisions, collectively hereinafter referred to as a matrix display. In a large LCD matrix display typically the LEDs are supplied in one or more strings of serially connected LEDs, thus sharing a common current.

In order supply a white backlight for the matrix display one of two basic techniques are commonly used. In a first technique one or more strings of “white” LEDs are utilized, the white LEDs typically comprising a blue LED with a phosphor which absorbs the blue light emitted by the LED and emits a white light. In a second technique one or more individual strings of colored LEDs are placed in proximity so that in combination their light is seen a white light. Often, two strings of green LEDs are utilized to balance one string each of red and blue LEDs.

In either of the two techniques, the strings of LEDs are in one embodiment located at one end or one side of the matrix display, the light being diffused to appear behind the LCD by a diffuser. In another embodiment the LEDs are located directly behind the LCD, the light being diffused so as to avoid hot spots by a diffuser. In the case of colored LEDs, a further mixer is required, which may be part of the diffuser, to ensure that the light of the colored LEDs are not viewed separately, but are rather mixed to give a white light. The white point of the light is an important factor to control, and much effort in design in manufacturing is centered on the need for a correct white point.

Each of the colored LED strings is typically intensity controlled by both amplitude modulation (AM) and pulse width modulation (PWM) to achieve an overall fixed perceived luminance. AM is typically used to set the white point produced by disparate colored LED strings by setting the constant current flow through the LED string to a value achieved as part of a white point calibration process and PWM is typically used to variably control the overall luminance, or brightness, of the monitor without affecting the white point balance. Thus the current, when pulsed on, is held constant to maintain the white point among the disparate colored LED strings, and the PWM duty cycle is controlled to dim or brighten the backlight by adjusting the average current. The PWM duty cycle of each color is further modified to maintain the white point, preferably responsive to a color sensor. The color sensor is arranged to receive the white light, and thus a color control feedback loop may be maintained. It is to be noted that different colored LEDs age, or reduce their luminance as a function of current, at different rates and thus the PWM duty cycle of each color must be modified over time to maintain the white point.

In an embodiment in which single color LEDs, such as white LEDs are used, a similar mechanism is supplied, however only the overall luminance need be controlled responsive to a photo-detector. It is to be noted that as the single color LEDs age, their luminance is reduced as a function of current. Additionally, their luminance is reduced as a function of LED temperature.

One known problem of LCD matrix displays is motion blur. One cause of motion blur is that the response time of the LCD is finite, and additionally the LCD exhibits sample and hold characteristics. Thus, there is a delay from the time of writing to the LCD pixel until the image changes. Furthermore, since each pixel is written once per scan, and then is held until the next scan, smooth motion is not possible. The eye notices the image being in the wrong place until the next sample, and interprets this as blur or smear.

This problem is resolved by a scanning backlight, in which the matrix display is divided horizontally into a plurality of regions, and the backlight for each region is illuminated for a short period of time in synchronization with the writing of the image. Ideally, the backlighting for the region is illuminated just after the pixel response time, and the illumination is held for a predetermined illumination frame time.

World Intellectual Property Organization International Publication S/N WO 2005/111976 published Nov. 24, 2005 to Fisekovic et al, the entire contents of which is incorporated herein by reference, is addressed to a scanning backlight for a matrix display. A sensing signal responsive to a plurality of lighting sources is supplied, the sensing signal being sampled at different times in coordination with the scanning period. Thus, a single sensor is responsive to a plurality of lighting sources. Unfortunately, as the effectiveness of optical partitions improve, thereby improving the operation of the scanning backlight and the matrix display as a whole, such a single sensor will not receive sufficient light from adjacent regions to be efficient.

U.S. Pat. No. 6,411,046 to Muthu issued Jun. 25, 2002, the entire contents of which is incorporated herein by reference, is addressed to a method of controlling the light output and color of LEDs in a luminaire by measuring color coordinates for each LED light source at different temperatures, storing the expressions of the color coordinates as a function of the temperatures, deriving equations for the color coordinates as a function of temperature, calculating the color coordinates and lumen output fractions on-line, and controlling the light output and color of the LEDs based upon the calculated color coordinates and lumen output fractions.

The above patent to Muthu represents one of a plurality of closed loop techniques for controlling color known to the prior art. Another technique, taught for example in EP 1067825 published Jan. 10, 2001 to Targetti, includes directly detecting the light with a plurality of filtered photo-detectors, and supplying a feedback means which compares the detected light to a pre-determined desired spectrum. The light driver is then adjusted to minimize the difference between the detected light and the pre-determined desired spectrum.

In any of the above closed loop feedback techniques, it is to be noted that LEDs exhibit a negative temperature coefficient in relation to luminance. Thus, as the temperature increases, the luminance of the LEDs decreases. Closed loop feedback techniques of the prior art teach increasing either the constant current or a pulse width modulation duty cycle to compensate for this reduced luminance. Unfortunately, such an increase in constant current, or duty cycle, responsive to the increased temperature, leads to a need for a still further increase in constant current, or duty cycle, with a resultant increase in LED temperature. Thus, in prior art closed loop feedback techniques a constant correlated color temperature and luminance is maintained, which may lead to thermal runaway.

The decrease in luminance as a result of temperature is somewhat ameliorated by a negative temperature coefficient in relation to the LED forward voltage drop. Thus, the increase in power dissipation in the LED as a result of the increase in current is somewhat balanced by the decrease in forward voltage drop. In the event that the absolute value of the luminance negative temperature coefficient is greater than the absolute value of the forward voltage drop temperature coefficient, thermal runaway may occur resulting in a burn out of the LEDs.

What is needed, and not provided by the prior art, is a means for preventing thermal runaway in an LED backlighting system.

### SUMMARY OF THE INVENTION

Accordingly, it is a principal object of the present invention to overcome the disadvantages of prior art. This is provided in the present invention by a backlighting system exhibiting a plurality of luminaires preferably arranged in a plurality of horizontally arranged regions. In one embodiment each of the luminaires comprises LED strings of a plurality of colors which in combination produce a white light. In another embodiment each of luminaires are constituted of LEDs of a single color, preferably white LEDs. Optical partitions are optionally further provided horizontally to limit any light spillover from a region to an adjacent region. At least two thermal sensors are further provided, the number of thermal sensors preferably being less than the number of regions. In an exemplary embodiment a thermal sensor is provided for the top region and the bottom region.

A controller receives the temperature indications from the thermal sensors and is operable to compare the temperature indications to a maximum temperature. In the event that the temperature has reached or exceeded the maximum temperature, and provided that the temperature has not exceeded a critical value, the luminance is reduced to reduce the power dissipation, and resultant temperature, of the LEDs. In one embodiment the reduced luminance results in a reduced constant current through the LEDs, and in another embodiment the reduced luminance results in a reduced PWM duty cycle. In the event of color LEDs, the correlated color temperature is maintained.

In one embodiment the controller calculates a temperature for each of the luminaires, and in another embodiment the controller utilizes the input temperature directly.

The invention provides for a backlighting system comprising: a controller; at least one luminaire comprising a plurality of LEDs; and at least one thermal sensor in communication with the controller, the controller being operative to control the luminance of the at least one luminaire responsive to the at least one thermal sensor. In one embodiment the control of the luminance comprises: in the event that a temperature indication responsive to an output of the at least one thermal sensor is greater than a first pre-determined maximum, reducing the luminance of at least one of the at least one luminaire.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a scanning backlight arrangement exhibiting a plurality of horizontally arranged regions and optical partitions between the regions according to the prior art;

FIG. 2A illustrates a high level block diagram of a scanning backlight arrangement in accordance with a principle of the invention in which a single color sensor and two thermal sensors are provided, the thermal sensors being associated with particular luminaires;

FIG. 2B illustrates a high level block diagram of a scanning backlight arrangement in accordance with a principle of the invention in which a single color sensor and two thermal sensors are provided, the thermal sensors being secured at pre-determined locations relative to the luminaires;

FIG. 2C illustrates a high level block diagram of a scanning backlight arrangement in accordance with a principle of the invention, in which the luminaires are constituted of single color LEDs, such as white LEDS, and in which a single photo-detector and two thermal sensors are provided, the thermal sensors being secured at pre-determined locations relative to the luminaires;

FIG. 3A illustrates a high level flow chart of the operation of the color manager of FIG. 2A to control the color of the luminaire of each lighting region based on the color sensor and thermal sensors in accordance with a principle of the invention;

FIG. 3B illustrates a high level flow chart of the operation of the color manager of FIG. 2B to control the color of the luminaire of each lighting region based on the color sensor and thermal sensors in accordance with a principle of the invention; and

FIG. 4 illustrates a high level flow chart of the operation of the controller of any of FIGS. 2A-2C, in accordance with a principle of the invention, to prevent thermal runaway.

### DETAILED DESCRIPTION OF PREFERRED EMBODIMENTS

The present embodiments enable a backlighting system exhibiting a plurality of luminaires preferably arranged in a plurality of horizontally arranged regions. In one embodiment each of the luminaires comprises LED strings of a plurality of colors which in combination produce a white light. In another embodiment each of luminaires are constituted of LEDs of a single color, preferably white LEDs. Optical partitions are optionally further provided horizontally to limit any light spillover from a region to an adjacent region. At least two thermal sensors are further provided, the number of thermal sensors preferably being less than the number of regions. In an exemplary embodiment a thermal sensor is provided for the top region and the bottom region.

A controller receives the temperature indications from the thermal sensors and is operable to compare the temperature indications to a maximum temperature. In the event that the temperature has reached or exceeded the maximum temperature, and provided that the temperature has not exceeded a critical value, the luminance is reduced to reduce the power dissipation, and resultant temperature, of the LEDs. In one embodiment the reduced luminance results in a reduced constant current through the LEDs, and in another embodiment the reduced luminance results in a reduced PWM duty cycle. In the event of color LEDs, the correlated color temperature is maintained.

In one embodiment the controller calculates a temperature for each of the luminaires, and in another embodiment the controller utilizes the input temperature directly.

The invention is being described in relation to a scanning backlight exhibiting optical partitions between horizontally arranged luminaires, however this is not meant to be limiting in any way. The invention is equally applicable to a non-scanning backlight, a backlight in which the luminaires are located at one end or one side of the matrix display, and a backlight in which the luminaires are arranged vertically.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

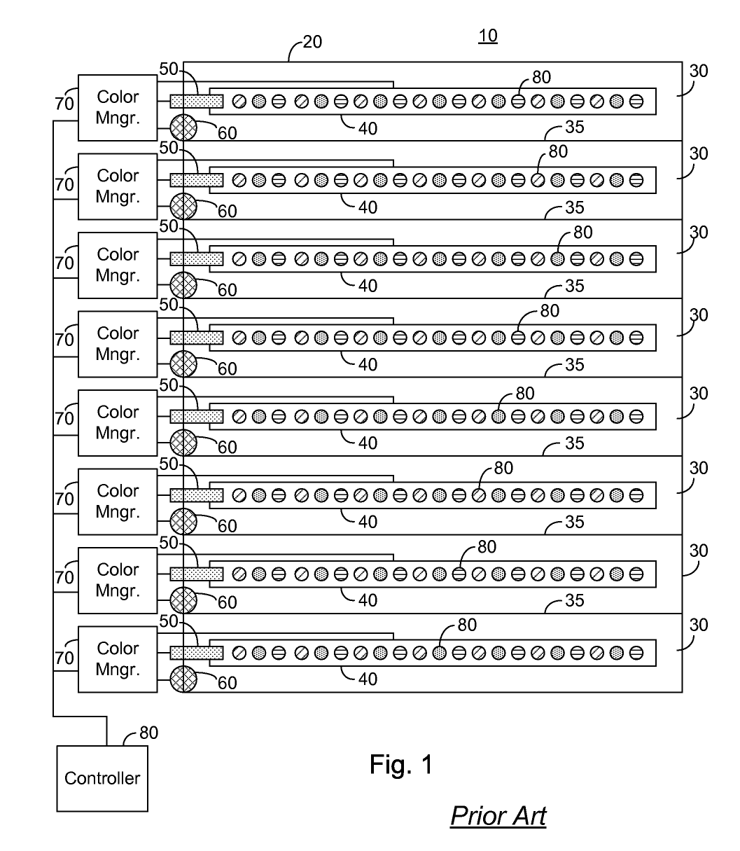

FIG. 1 illustrates a high level block diagram of a scanning backlight arrangement 10 for a matrix display exhibiting a plurality of horizontally arranged regions and optical partitions between the regions according to the prior art. Scanning backlight arrangement 10 comprises: a matrix display 20 divided into a plurality of lighting regions 30 by a plurality of optical partitions 35, each of the lighting regions 30 comprising a luminaire 40, a thermal sensor 50, and a color sensor 60; a plurality of color managers 70, each of the color managers 70 being associated with a particular lighting region 30; and a controller 80. Each luminaire 40 is comprised of at least one LED string 80. In an exemplary embodiment the at least one LED string 80 comprises a red LED string, a blue LED string and a green LED string. Thermal sensors 50 may be arranged to output a signal reflective of the temperature of the LEDs of luminaire 40 or may be arranged to output a signal reflective of the temperature of a predetermined location associated with each luminaire 40. Each color manager 70 is connected to receive the output of the associated thermal sensor 50 and color sensor 60 and is connected to control a drive signal of the associated luminaire 40. Each color manager 70 further receives an illumination signal from controller 80.

In operation each color manager 70, responsive to the associated thermal sensor 50 and color sensor 60 controls the drive signal of LED strings 80 of the luminaire 40 so as to maintain an appropriate color balance. Illumination from each of the luminaires 40 is restricted to a particular lighting region 30 by optical partitions 35. In an exemplary embodiment the LED strings 80 are each controlled by an electronically controlled switch, such as a field effect transistor (FET), and LED strings 80 are each pulse width modulated via the FET so as to maintain the appropriate color balance. Controller 80 is operable to enable each luminaire 40 via the associated color manager 70 so as to synchronize the illumination of each of the lighting regions 30 with an overall scanning and refresh of matrix display 20. Scanning backlight arrangement 10 is thus operable to maintain a constant uniform color across each of the lighting regions 30, however the requirement for an individual color sensor, thermal sensor and color manager for each lighting region 30 is costly.

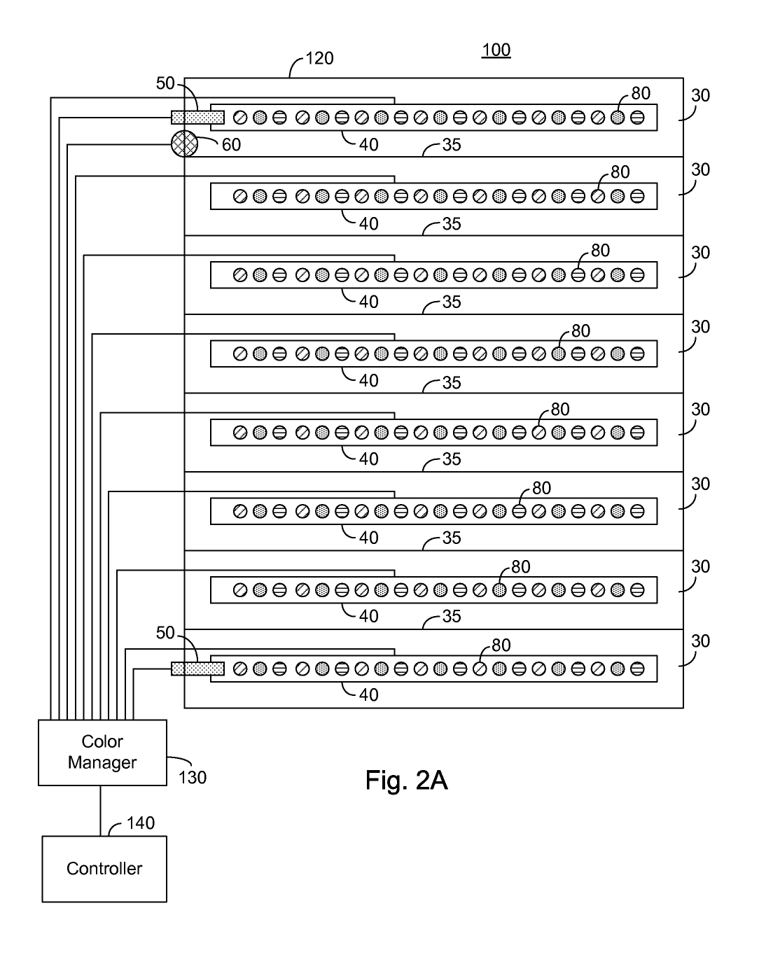

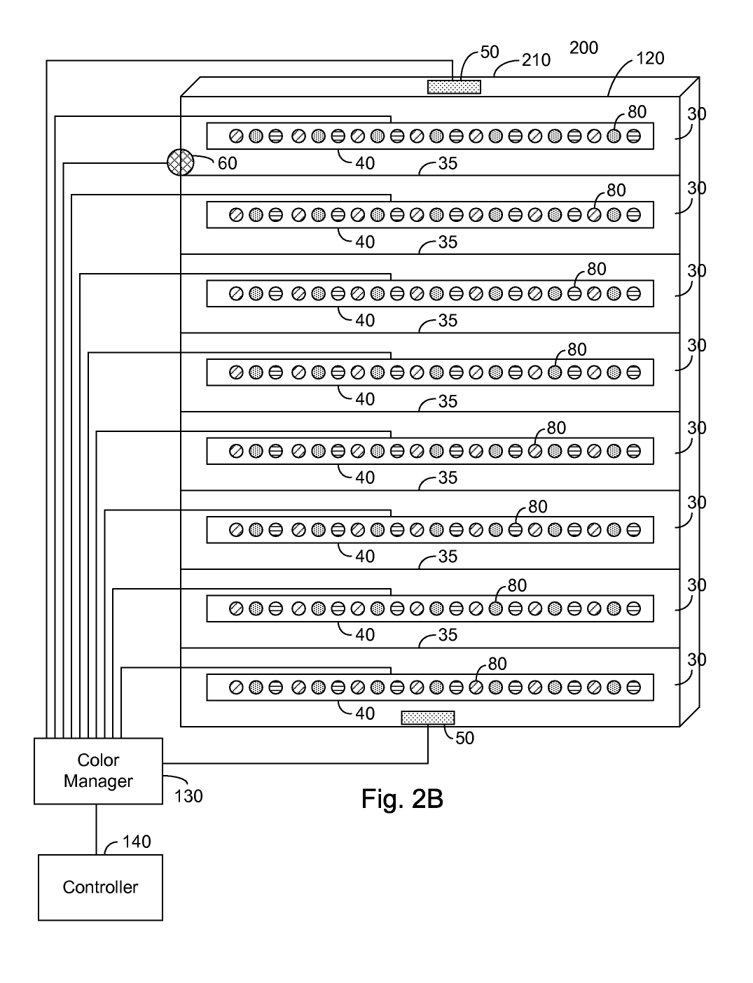

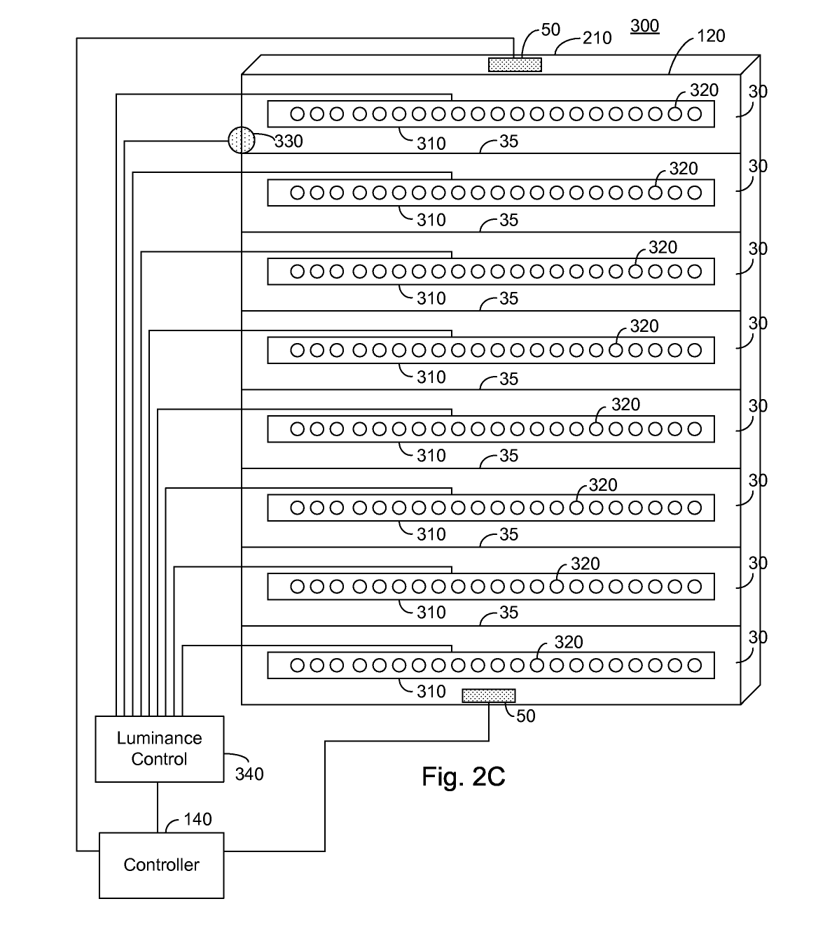

FIG. 2A illustrates a high level block diagram of a scanning backlight arrangement 100 in accordance with a principle of the invention in which a single color sensor 60 and two thermal sensors 50 are provided, the thermal sensors being associated with particular luminaires. Scanning backlight arrangement 100 comprises: a matrix display 120 divided into a plurality of lighting regions 30 by a plurality of optical partitions 35, each of the lighting regions comprising a luminaire 40; a color manager 130; and a controller 140. Each luminaire 40 is comprised of at least one LED string 80. In an exemplary embodiment the at least one LED string 80 comprises a red LED string, a blue LED string and a green LED string. At least one lighting region 30 is provided with color sensor 60 and at least two luminaires 40 are each provided with thermal sensor 50. In an exemplary embodiment two thermal sensors 50 are provided, a first thermal sensor 50 providing temperature information regarding the LED strings 80 of the luminaire 40 associated with the top lighting region 30 and a second thermal sensor 50 providing temperature information regarding the LED strings 80 of the luminaire 40 associated with the bottom lighting region 30. Color sensor 60 is arranged to provide optical sensing information from a particular one of the lighting regions 30, and in one embodiment provides optical sensing information from a lighting region 30 having disposed therein a thermal sensor 50, however this is not meant to be limiting in any way. In another embodiment (not shown) color sensor 60 is disposed in a lighting region 30 not having a thermal sensor 50 disposed therein. Scanning backlight arrangement 100 is illustrated as having a thermal sensor 50 disposed within a top lighting region 30 and a bottom lighting region 30, however this is not meant to be limiting in any way. Temperatures sensors 50 may be provided for other lighting regions 30 and not provided in the top or bottom lighting region 30 without exceeding the scope of the invention. In another embodiment (not shown), additional thermal sensors 50 are provided. Preferably sufficient luminaires 40 are selected to receive thermal sensors 50 so as to enable the approximate determination of the temperature of the LED strings 80 in all luminaires 40 as will be explained further hereinto below.

Color manager 130 is connected to receive the output of each thermal sensor 50 and to receive the output of color sensor 60. Color manager 130 is further connected to control the drive signals of each luminaire 40, to receive an illumination signal from controller 140 and to communicate temperature information received from thermal sensor 50 to controller 140.

In operation color manager 130, responsive to the at least two thermal sensors 50 and the color sensor 60 controls a drive signal associated with each LED string 80 of the luminaires 40. In one embodiment, color manager 130 calculates the temperature for each luminaire 40 for which a thermal sensor 50 is not provided and generates a control signal responsive thereto. In an exemplary embodiment the calculation involves interpolation of the temperature for each of the luminaires 40 assuming a linear relationship based on the location of the temperatures sensors 50. In another embodiment a relationship is first determined based on thermodynamics of the design and physical layout of the monitor. In yet another embodiment the relationship is determined based on actual measurements of one or more production or engineering samples. Responsive to the calculated estimated temperatures, and the input of actual temperature measurements of thermal sensors 50, color manager 130 calculates the color coordinates of each of the LED strings 80 of each of the luminaires 40.

Color manager 130, responsive to the input from color sensor 60, and the above calculated color coordinates, is operable to calculate the appropriate driving signal for each of the LED strings 80 of each luminaire 40 so as to achieve a uniform color balance for each luminaire 40 of matrix display 120. In particular, the drive signals for each of a particular color LED string 80 of different luminaires 40 may not be identical and need to be individually determined. Illumination from each of the luminaires 40 is restricted to a particular lighting region 30 by optical partitions 35. In an exemplary embodiment the LED strings 80 are each controlled by an electronically controlled switch, such as a field effect transistor (FET), and LED strings 80 are each pulse width modulated via the FET so as to maintain the appropriate color balance. In one embodiment, the LED strings 80 are pre-selected to be sufficiently uniform such that the only substantial difference in the color output between the LED strings 80 of different luminaires 40 is a consequence of temperature differences. In another embodiment, the illumination output of each LED string 80 is measured during an initial calibration stage, preferably as part of the manufacturing process, and the values are stored within color manager 130 for use in calculating the appropriate drive signal to color control each of the LED strings 80. Thus, a single color sensor 60 in coordination with at least two thermal sensors 50 are utilized to control the color of all LED strings 80 of scanning backlight arrangement 100.

Controller 140 is operable to enable each luminaire 40 via color manager 130 so as to synchronize the illumination of each of the lighting regions 30 with an overall scanning and refresh of matrix display 120. Scanning backlight arrangement 100 is thus operable to maintain a constant color across each of the lighting regions 30, without requiring an individual color sensor and thermal sensor for each lighting region 30.

The above has been described in an embodiment in which a single color sensor 60 is provided, however this is not meant to be limiting in any way. The invention is equally applicable to an embodiment in which more than one color sensor 60 is provided. In the event of a plurality of color sensors 60 being provided, an average value of the color sensors may be utilized. Alternatively, a first color sensor 60 may be utilized to control the color of a first plurality of lighting regions 30, including the lighting region comprising the first color sensor 60, and a second color sensor 60 may be utilized to control the color of a second plurality of lighting regions 30, including the lighting region comprising the second color sensor 60. Thus matrix display 120 may be subdivided into the appropriate number of groups depending on the number of color sensors 60, and each color sensor may be utilized to control one or more lighting regions 30 within the group.

The above has been described in an embodiment in which two thermal sensors 50 are provided, however this is not meant to be limiting in any way. The invention is equally applicable to an embodiment in which more than two thermal sensors 50 are provided. The temperature of the LED strings 80 within lighting regions 30 not exhibiting a thermal sensor 50 are calculated based on thermal sensors 50 of the lighting regions 30 where supplied. The respective thermal sensors 50 are utilized to determine the temperature of the associated LED strings 80 of luminaire 40 for which thermal sensor 50 is provided.

FIG. 2B illustrates a high level block diagram of a scanning backlight arrangement 200 in accordance with a principle of the invention in which a single color sensor 60 and two thermal sensors 50 are provided, the thermal sensors being secured at predetermined locations relative to the luminaires. Scanning backlight arrangement 200 comprises: a matrix display 120 divided into a plurality of lighting regions 30 by a plurality of optical partitions 35, each of the lighting regions comprising a luminaire 40; a color manager 130; and a controller 140. Each luminaire 40 is comprised of at least one LED string 80 and the luminaires 40 are secured within a chassis 210. In an exemplary embodiment the at least one LED string 80 comprises a red LED string, a blue LED string and a green LED string. At least one lighting region 30 is provided with color sensor 60, and at least two temperatures sensors 50 are provided secured at predetermined location relative to the plurality of luminaires 40. In an exemplary embodiment two thermal sensors 50 are provided, a first thermal sensor 50 providing temperature information associated with the top area of chassis 210 and a second thermal sensor 50 providing temperature information regarding the bottom area of chassis 210. Color sensor 60 is arranged to provide optical sensing information from a particular one of the lighting regions 30, and in one embodiment provides optical sensing information from a lighting region 30 having disposed therein a thermal sensor 50, however this is not meant to be limiting in any way. In another embodiment (not shown) color sensor 60 is disposed in a lighting region 30 not having a thermal sensor 50 disposed therein. Scanning backlight arrangement 200 is illustrated as having a thermal sensor 50 disposed within a top area of chassis 210 and a bottom area of chassis 210, however this is not meant to be limiting in any way. Temperatures sensors 50 may be provided in other areas of chassis 210 and not provided in the top or bottom areas without exceeding the scope of the invention. In another embodiment (not shown), additional thermal sensors 50 are provided. Preferably sufficient areas are selected to receive thermal sensors 50 so as to enable the approximate determination of the temperature of the LED strings 80 in all lighting regions 30 as will be explained further hereinto below.

Color manager 130 is connected to receive the output of each thermal sensor 50 and to receive the output of color sensor 60. Color manager 130 is further connected to control the drive signals of each luminaire 40, to receive an illumination signal from controller 140 and to communicate temperature information received from thermal sensor 50 to controller 140.

In operation color manager 130, responsive to the at least two thermal sensors 50 and the color sensor 60 controls a drive signal associated with each LED string 80 of the luminaires 40. In one embodiment, color manager 130 calculates an approximate temperature for each luminaire 40 and generates a control signal responsive thereto. In an exemplary embodiment the calculation involves interpolation of the temperature for each of the luminaires 40 based on the location of the temperatures sensors 50. In another embodiment a relationship is first determined based on thermodynamics of the design and physical layout of the monitor. In yet another embodiment the relationship is determined based on actual measurements of one or more production or engineering samples. Responsive to the calculated estimated temperatures color manager 130 calculates the color coordinates of each of the LED strings 80 of each of the luminaires 40.

Color manager 130, responsive to the input from color sensor 60, and the above calculated color coordinates, is operable to calculate the appropriate driving signal for each of the LED strings 80 of each luminaire 40 so as to achieve a uniform color balance for each luminaire 40 of matrix display 120. Illumination from each of the luminaires 40 is restricted to a particular lighting region 30 by optical partitions 35. In an exemplary embodiment the LED strings 80 are each controlled by an electronically controlled switch, such as a field effect transistor (FET), and LED strings 80 are each pulse width modulated via the FET so as to maintain the appropriate color balance. In one embodiment, the LED strings 80 are pre-selected to be sufficiently uniform such that the only substantial difference in the color output between the LED strings 80 of different luminaires 40 is a consequence of temperature differences. In another embodiment, the illumination output of each LED string 80 is measured during an initial calibration stage, preferably as part of the manufacturing process, and the values are stored within color manager 130 for use in calculating the appropriate drive signal to color control each of the LED strings 80. Thus, a single color sensor 60 in coordination with at least two thermal sensors 50 are utilized to control the color of all LED strings 80 of scanning backlight arrangement 200.

Controller 140 is operable to enable each luminaire 40 via color manager 130 so as to synchronize the illumination of each of the lighting regions 30 with an overall scanning and refresh of matrix display 120. Scanning backlight arrangement 200 is thus operable to maintain a constant color across each of the lighting regions 30, without requiring an individual color sensor for each lighting region 30 and an individual thermal sensor associated with each luminaire 40.

The above has been described in an embodiment in which a single color sensor 60 is provided, however this is not meant to be limiting in any way. The invention is equally applicable to an embodiment in which more than one color sensor 60 is provided. In the event of a plurality of color sensors 60 being provided, an average value of the color sensors may be utilized. Alternatively, a first color sensor 60 may be utilized to control the color of a first plurality of lighting regions 30, including the lighting region comprising the first color sensor 60, and a second color sensor 60 may be utilized to control the color of a second plurality of lighting regions 30, including the lighting region comprising the second color sensor 60. Thus matrix display 120 may be subdivided into the appropriate number of groups depending on the number of color sensors 60, and each color sensor may be utilized to control one or more lighting regions 30 within the group.

The above has been described in an embodiment in which two thermal sensors 50 are provided, however this is not meant to be limiting in any way. The invention is equally applicable to an embodiment in which more than two thermal sensors 50 are provided. The temperature of the LED strings 80 are calculated based on inputs from provided thermal sensors 50 and their associated locations in relation to luminaires 40.

FIG. 2C illustrates a high level block diagram of a scanning backlight arrangement 300 in accordance with a principle of the invention, in which a plurality of luminaires 310 are constituted of one or more strings of single color LEDs 320, such as white LEDS, and in which a single photo-detector 330 and two thermal sensors 50 are provided, the thermal sensors being secured at pre-determined locations relative to the luminaires. Scanning backlight arrangement 300 comprises: a matrix display 120 divided into a plurality of lighting regions 30 by a plurality of optical partitions 35, each of the lighting regions comprising a luminaire 310; a luminance control 340; and a controller 140. Each luminaire 310 is secured within a chassis 210. At least one lighting region 30 is provided with photo-detector 330, and at least two temperatures sensors 50 are provided secured at pre-determined location relative to the plurality of luminaires 310. In an exemplary embodiment two thermal sensors 50 are provided, a first thermal sensor 50 providing temperature information associated with the top area of chassis 210 and a second thermal sensor 50 providing temperature information regarding the bottom area of chassis 210. Photo-detector 330 is arranged to provide optical sensing information from a particular one of the lighting regions 30, and in one embodiment provides optical sensing information from a lighting region 30 having disposed therein a thermal sensor 50, however this is not meant to be limiting in any way. In another embodiment (not shown) photo-detector 330 is disposed in a lighting region 30 not having a thermal sensor 50 disposed therein. Scanning backlight arrangement 300 is illustrated as having a thermal sensor 50 disposed within a top area of chassis 210 and a bottom area of chassis 210, however this is not meant to be limiting in any way. Temperatures sensors 50 may be provided in other areas of chassis 210 and not provided in the top or bottom areas without exceeding the scope of the invention. In another embodiment (not shown), additional thermal sensors 50 are provided. Preferably sufficient areas are selected to receive thermal sensors 50 so as to enable the approximate determination of the temperature of the LEDs 320 in all lighting regions 30 as will be explained further hereinto below.

The above has been described in which a single photo-detector 330 is supplied, however this is not meant to be limiting in any way. In another embodiment a photo-detector 330 is provided for each lighting region 30 without exceeding the scope of the invention.

Luminance control 340 is arranged to receive the output of photo-detector 330 and controller 140 is arranged to receive the output of each thermal sensor 50. Luminance control 340 is further connected to control the drive signals of each luminaire 310 and to receive an illumination signal from controller 140. Optionally, luminance control 340 receives temperature information associated with thermal sensors 50 from controller 140.

In operation luminance control 340, responsive to photo-detector 330, controls a drive signal associated with each string of single color LEDs 320 of the luminaires 310 to maintain an overall luminance responsive to an illumination signal level from controller 140. Controller 140 is operative, as will described further hereinto below, to monitor a temperature component of associated with chassis 210, and in the event the temperature component has exceeded a maximum predetermined temperature, without exceeding a critical temperature, to reduce the luminance level by adjusting the illumination signal level to luminance control 340. In one embodiment the temperature component comprises an interpolation of the temperature for each of the luminaires 310 based on the location of the temperatures sensors 50. In another embodiment a relationship is first determined based on thermodynamics of the design and physical layout of the monitor. In yet another embodiment the relationship is determined based on actual measurements of one or more production or engineering samples.

In the event that the temperature component has exceeded a critical temperature, at least one luminaire 310 is shut down, and an overheat message is sent to a host (not shown).

Luminance control 340, responsive to the luminance level signal input from controller 140 and the feedback signal from photo-detector 330 is operable to generate the appropriate driving signal for each string of single color LEDs 320 of the luminaires 310 so as to achieve a uniform luminance for matrix display 120. Preferably, illumination from each of the luminaires 40 is restricted to a particular lighting region 30 by optical partitions 35. In an exemplary embodiment the strings of single colored LEDs 320 are each controlled by an electronically controlled switch, such as a field effect transistor (FET), and strings of single colored LEDs 320 are each pulse width modulated via the FET so as to maintain the appropriate balance. Thus, a single photo-detector 330 in coordination with at least two thermal sensors 50 are utilized to control the color of all strings of single colored LEDs 320 of scanning backlight arrangement 300.

Controller 140 is operable to enable each luminaire 310 via luminance control 340 so as to synchronize the illumination of each of the lighting regions 30 with an overall scanning and refresh of matrix display 120.

The above has been described in an embodiment in which a single photo-detector 330 is provided, however this is not meant to be limiting in any way. The invention is equally applicable to an embodiment in which more than one photo-detector 330 is provided. In the event of a plurality of photo-detectors 330 being provided, an average value of the photo-detectors 330 may be utilized. Alternatively, a first photo-detector 330 may be utilized to control the color of a first plurality of lighting regions 30, including the lighting region comprising the first photo-detector 330, and a second photo-detector 330 may be utilized to control the color of a second plurality of lighting regions 30, including the lighting region comprising the second photo-detector 330. Thus matrix display 120 may be subdivided into the appropriate number of groups depending on the number of photo-detectors 330, and each photo-detector 330 may be utilized to control one or more lighting regions 30 within the group.

The above has been described in an embodiment in which two thermal sensors 50 are provided, however this is not meant to be limiting in any way. The invention is equally applicable to an embodiment in which more than two thermal sensors 50 are provided. The temperature of the LEDs 320 of luminaires 310 are calculated based on inputs from provided thermal sensors 50 and their associated locations in relation to luminaires 40.

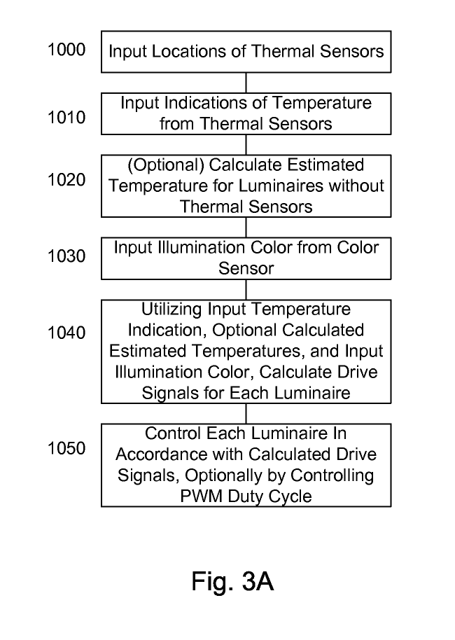

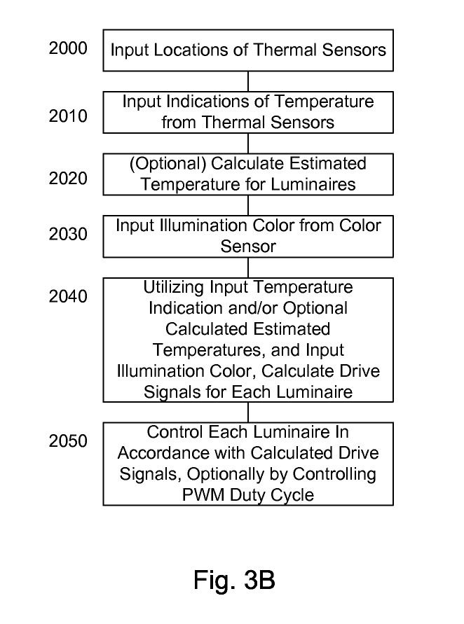

FIG. 3A illustrates a high level flow chart of the operation of color manager 130 of FIG. 2A to control the color of the luminaire 40 of each lighting region 30 based on color sensor 60 and temperatures sensors 50 in accordance with a principle of the invention. In stage 1000 the physical locations of the luminaires 40 having associated therewith a thermal sensor 50 are input, and the physical relationship between the luminaires 40 not exhibiting a thermal sensor 50 and the provided thermal sensors 50 is input. Thus, as indicated above, at least two thermal sensors 50 are provided, and stage 1000 further provides full location information regarding luminaires 40 of lighting regions 30 for which a thermal sensor 50 is not provided and the interrelation thereof. In one embodiment, as described above, the physical location enables a linear relationship to be calculated for all luminaires 40 located between the luminaires 40 provided with thermal sensors 50. In another embodiment, the physical location further comprises a pre-determined thermodynamic relationship between the temperatures of the luminaires 40 provided with thermal sensors and all other luminaires 40 of scanning backlight arrangement 100. The pre-determined relationship may be determined based on the design and physical layout or based on actual measurement of one or more production or engineering samples. In an exemplary embodiment thermal sensors 50 are provided in a top and bottom luminaire 40 in a direction of normal heat flow. In the event that a plurality of color sensors 60 is provided, their physical location and relationship to each of the light regions 30 are input.

In stage 1010, a reading of each thermal sensor 50 is input, the reading being associated with the LED temperature of a LED string 80 of the luminaire 40 to which thermal sensor 50 is associated. In optional stage 1020 an estimated temperature is calculated for each luminaire 40 of each lighting zone 30 not provided with a thermal sensor 50. In an exemplary embodiment the calculation involves interpolation of the temperature for each of the luminaires 40 located between the luminaires 40 provided with thermal sensors 50 assuming a linear temperature relationship. In another embodiment the thermodynamic relationship input in stage 1000 is utilized to calculate the estimated temperatures.

In stage 1030 the illumination color is input from color sensor 60. In an embodiment in which a plurality of color sensors 60 are provided, each of the outputs are input, and assigned to subgroups of regions or averaged as described above. In stage 1040, utilizing the temperature indications input in stage 1010, the optional estimated temperatures calculated in stage 1020 and the illumination color input in stage 1030, the drive signals to control the color of each luminaire 40 are calculated. In one embodiment the drive signals are calculated by estimating the lumen output fractions and chromaticity coordinates associated with LED light sources constituting each LED string 80 based on the input or calculated estimated temperature, respectively, and adjusting a PWM signal responsive to input from color sensor 60. In another embodiment, the drive signals for the luminaire 40 having associated therewith color sensor 60 is determined in stage 1040. Drive signals for other luminaires 40 are calculated as a function of the determined drive signals and the calculated temperature for each of the luminaires 40.

In stage 1050 each luminaire 40 is controlled in accordance with the calculate drive signal of stage 1040, preferably by adjusting the PWM duty cycle associated with each LED string 80 of each luminaire 40. In an exemplary embodiment the drive signals are output as PWM control signals to enable and disable LED strings 80.

FIG. 3B illustrates a high level flow chart of the operation of color manager 130 of FIG. 2B to control the color of the luminaire 40 of each lighting region 30 based on color sensor 60 and temperatures sensors 50 in accordance with a principle of the invention. In stage 2000 the physical locations of the thermal sensors 50 are input, and the thermodynamic relationship between luminaires 40 and the provided thermal sensors 50 is input. In one embodiment, as described above, the physical location enables a straight line temperature relationship to be calculated for all luminaires 40. The thermodynamic relationship may be determined based on the design and physical layout or based on actual measurement of one or more production or engineering samples. In an exemplary embodiment thermal sensors 50 are provided in a top and bottom location of chassis 210 secured at particular locations relative to the plurality of luminaires 40, preferably in a direction of normal heat flow. In the event that a plurality of color sensors 60 is provided, their physical location and relationship to each of the light regions 30 are input.

In stage 2010, a reading from each thermal sensor 50 is input. In optional stage 2020 an estimated temperature is calculated for each luminaire 40 of each lighting zone 30. In an exemplary embodiment the calculation involves interpolation of the temperature for each of the luminaires 40 located between the thermal sensors 50 assuming a linear temperature relationship. In another embodiment the thermodynamic relationship input in stage 2000 is utilized to calculate the estimated temperatures.

In stage 2030 the illumination color is input from color sensor 60. In an embodiment in which a plurality of color sensors 60 are provided, each of the outputs are input, and assigned to subgroups of regions or averaged as described above. In stage 2040, utilizing the temperature indications input in stage 2010, the optional estimated temperatures calculated in stage 2020 and the illumination color input in stage 2030, the drive signals to control the color of each luminaire 40 are calculated. In one embodiment the drive signals are calculated by estimating the lumen output fractions and chromaticity coordinates associated with LED light sources constituting each LED string 80 based on the calculated estimated temperature, and adjusting a PWM signal responsive to input from color sensor 60. In stage 2050 each luminaire 40 is controlled in accordance with the calculate drive signal of stage 2040, preferably by adjusting the PWM duty cycle associated with each LED string 80 of each luminaire 40. In an exemplary embodiment the drive signals are output as PWM control signals to enable and disable LED strings 80.

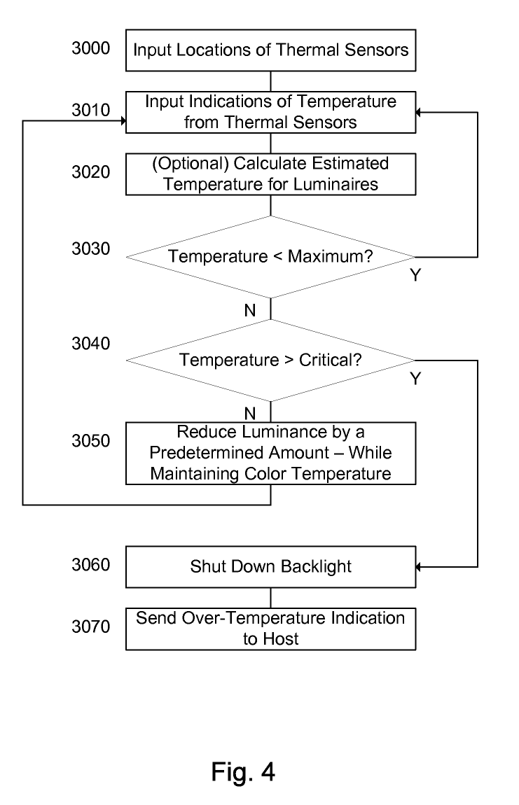

FIG. 4 illustrates a high level flow chart of the operation of controller 140 of any of FIGS. 2A-2C, in accordance with a principle of the invention, to prevent thermal runaway. In stage 3000 the physical locations of the thermal sensors 50 are input, and the thermodynamic relationship between luminaires 40, 310 respectively, and the provided thermal sensors 50 is input. In one embodiment, as described above, the physical location enables a straight line temperature relationship to be calculated for all luminaires 40, 310. The thermodynamic relationship may be determined based on the design and physical layout or based on actual measurement of one or more production or engineering samples. In an exemplary embodiment thermal sensors 50 are provided in a top and bottom location of chassis 210 secured at particular locations relative to the plurality of luminaires 40, 310 preferably in a direction of normal heat flow.

In stage 3010, a reading from each thermal sensor 50 is input. In optional stage 3020 an estimated temperature is calculated for each luminaire 40, 310 of each lighting zone 30. In an exemplary embodiment the calculation involves interpolation of the temperature for each of the luminaires 40, 310 located between the thermal sensors 50 assuming a linear temperature relationship. In another embodiment the thermodynamic relationship input in stage 3000 is utilized to calculate the estimated temperatures.

In stage 3030, the temperature is compared with a maximum safe operating temperature. In one embodiment, in which stage is 3010 is implemented, the temperature of each luminaire 40, 310 is compared to the maximum safe operating temperature. In another embodiment, the temperature indications from thermal sensors 50 are directly utilized. In yet another embodiment, a function the temperature indications from thermal sensors 50 are utilized. In the event that the temperature is less than the maximum safe operating temperature, stage 3010 is again performed, preferably after a pre-determined wait period.

In the event that in stage 3030 the temperature is not less than the maximum safe operating temperature, in stage 3040 the temperature is compared with a critical temperature. In one embodiment, in which stage is 3010 is implemented, the temperature of each luminaire 40, 310 is compared to the critical temperature. In another embodiment, the temperature indications from thermal sensors 50 are directly utilized. In yet another embodiment, a function the temperature indications from thermal sensors 50 are utilized. In the event that the temperature is greater than the critical temperature, in stage 3060 at least one luminaire 40, 310 is shut down. In one preferred embodiment all luminaires 40, 310 are shut down, and in another preferred embodiment alternate luminaires 40, 310 are shut down, thereby reducing overall luminance by 50%, and power dissipation. In stage 3070, an over temperature indication is sent to a host.

In the event that in stage 3030 the temperature is less than the maximum safe operating temperature, in stage 3050 the luminance of luminaires 40, 310 is reduced so as to reduce the power dissipation and resultant heat thereof. In one embodiment the luminance is reduced by a pre-determined amount, preferably by adjusting the luminance level signal output by controller 140. In another embodiment the luminance is reduced to a predetermined amount, preferably by adjusting the luminance level signal output by controller 140. In the event of colored LED strings, the color temperature of luminaire 40 is maintained. Stage 3010, as described above is then performed.

Thus the present embodiments enable a backlighting system exhibiting a plurality of luminaires preferably arranged in a plurality of horizontally arranged regions. In one embodiment each of the luminaires comprises LED strings of a plurality of colors which in combination produce a white light. In another embodiment each of luminaires are constituted of LEDs of a single color, preferably white LEDs. Optical partitions are optionally further provided horizontally to limit any light spillover from a region to an adjacent region. At least two thermal sensors are further provided, the number of thermal sensors preferably being less than the number of regions. In an exemplary embodiment a thermal sensor is provided for the top region and the bottom region.

A controller receives the temperature indications from the thermal sensors and is operable to compare the temperature indications to a maximum temperature. In the event that the temperature has reached or exceeded the maximum temperature, and provided that the temperature has not exceeded a critical value, the luminance is reduced to reduce the power dissipation, and resultant temperature, of the LEDs. In one embodiment the reduced luminance results in a reduced constant current through the LEDs, and in another embodiment the reduced luminance results in a reduced PWM duty cycle. In the event of color LEDs, the correlated color temperature is maintained.

In one embodiment the controller calculates a temperature for each of the luminaires, and in another embodiment the controller utilizes the input temperature directly.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description and which are not in the prior art.

We claim:

1. A backlighting system comprising:
a controller;
at least one luminaire comprising a plurality of LEDs; and
at least one thermal sensor in communication with said controller,
said controller being operative to control the luminance of said at least one luminaire responsive to said at least one thermal sensor, wherein said control comprises:
in the event that a temperature indication responsive to an output of said at least one thermal sensor is greater than a first pre-determined maximum, reduce the luminance of at least one of said at least one luminaire.

2. A backlighting system according to claim 1, wherein said control of the luminance further comprises:
in the event that a temperature indication responsive to an output of said at least one thermal sensor is greater than a second pre-determined maximum, disable at least one of said at least one luminaire.

3. A backlighting system according to claim 2, wherein said controller is further operative, in the event that a temperature indication responsive to an output of said at least one thermal sensor is greater than said second pre-determined maximum, to transmit an over-temperature indication to a host.

4. A backlighting system according to claim 1, wherein said control of the luminance further comprises:
in the event that a temperature indication responsive to an output of said at least one thermal sensor is greater than said first pre-determined maximum, reduce the luminance of all of said at least one luminaire.

5. A backlighting system according to claim 1, wherein said luminance is reduced by a pre-determined amount.

6. A backlighting system according to claim 1, wherein said temperature indication comprises an interpolated temperature indication for each of said at least one luminaire.

7. A backlighting system according to claim 1, wherein at least one of said at least one thermal sensor is associated with a particular one of said at least one luminaire.

8. A backlighting system according to claim 1, wherein said at least one thermal sensor comprises a plurality of thermal sensors, each of said plurality of thermal sensors secured at a particular location relative to said at least one luminaire.

9. A backlighting system according to claim 8, wherein said at least one luminaire is secured to a chassis exhibiting a top, and wherein said particular location of one of said plurality of thermal sensors is associated with said top of said chassis.

10. A backlighting system according to claim 8, wherein said at least one luminaire comprises a plurality of luminaires arrange horizontally and stacked vertically, and wherein said particular location of one of said plurality of thermal sensors is associated with a top one of said horizontally arranged stacked plurality of luminaires.

11. A backlighting system according to claim 1, further comprising a photo-sensor arranged to receive light from said at least one luminaire and a luminance control responsive to said photo-sensor and said controller, wherein said at least one luminaire is responsive to an output of said luminance control, and wherein said luminance control is operative in cooperation with said photo-sensor to maintain the luminance of said at least one luminaire responsive to said controller.

12. A method of backlighting comprising:
providing at least one luminaire comprising a plurality of LEDs;
sensing a temperature component associated with said provided at least one luminaire; and
reducing, in the event that said sensed temperature component is greater than a first pre-determined maximum, the luminance of at least one of said provided at least one luminaire.

13. A method according to claim 12, further comprising:
disabling, in the event that said sensed temperature component is greater than a second pre-determined maximum, at least one of said provided at least one luminaire.

14. A method according to claim 13, further comprising in the event that said sensed temperature component is greater than said second pre-determined maximum, transmitting an over-temperature indication.

15. A method according to claim 12, wherein said provided at least one luminaire comprises a plurality of luminaires, and wherein said reducing the luminance of at least one of said provided at least one luminaire, comprises reducing the luminance of all of said provided plurality of luminaires.

16. A method according to claim 12, wherein said reducing the luminance is by a pre-determined amount.

17. A method according to claim 12, wherein said sensing a temperature component associated with said provided at least one luminaire further comprises interpolating a temperature component for at least one luminaire.

18. A method according to claim 12, wherein said sensed temperature component is associated with a particular one of said provided at least one luminaire.

19. A method according to claim 12, wherein said sensed temperature component comprises a plurality of sensed temperature components, each of said sensed temperature components being associated with a particular location relative to said provided at least one luminaire.

20. A method according to claim 12, further comprising:
providing a chassis exhibiting a top; and
securing said provided at least one luminaire to said provided chassis,
wherein said sensed temperature component is associated with the top of said provided chassis.

21. A method according to claim 12, wherein said provided at least one luminaire comprises a plurality of luminaires, the method further comprising:
arranging said provided plurality of luminaires horizontally and stacked vertically, and wherein said sensed temperature component is associated with a top one of said horizontally arranged stacked provided plurality of luminaires.

22. A method of backlighting according to claim 12, further comprising:
providing a photo-sensor arranged to receive light from said at least one luminaire;
maintaining a luminance level of said provided at least one luminaire responsive to said provided photo-sensor; and
controlling said luminance level responsive to said sensed temperature component, wherein said controlling comprises said reducing.

23. A backlighting system comprising:
at least one color sensor;
a controller responsive to said at least one color sensor;
at least one luminaire comprising a plurality of colored LED strings, each of said at least one color sensor being associated with a particular one of said at least one luminaire; and
at least one thermal sensor in communication with said controller,
said controller being operative to:
control the luminance and color temperature of said at least one luminaire responsive to said at least one thermal sensor and said at least one color sensor, and
in the event that a temperature indication responsive to an output of said at least one thermal sensor is greater than a pre-determined maximum, reduce the luminance of at least one of said at least one luminaire while maintaining the color temperature of said reduced luminance luminaire.

24. A backlighting system according to claim 23, wherein said controller determines first drive signals for said at least one luminaire having associated therewith a color sensor responsive to said color sensor, and determines second drive signals for said luminaires not having associated therewith a color sensor responsive to said determined first drive signals and said at least one thermal sensor.
